(19) United States
(12) Patent Application Publication
(10) Pub. No.: US 2026/0172454 A1
(43) Pub. Date: Jun. 18, 2026

(54) METHOD AND COMMUNICATION DEVICE FOR COMMUNICATION USING IPSEC

(71) Applicant: Telefonaktiebolaget LM Ericsson (publ), Stockholm (SE)

(72) Inventors: Daiying LIU, Beijing (CN); Gang YANG, Beijing (CN); Yiqun LI, Beijing (CN)

(21) Appl. No.: 19/125,828

(22) PCT Filed: Nov. 3, 2022
(86) PCT No.: PCT/CN2022/129661

§ 371 Date: Apr. 30, 2025

(51) Int. Cl. H04L 9/40

(52) U.S. Cl. CPC H04L 63/205; H04L 63/0428

(57) ABSTRACT

A method and a communication device are disclosed for communication using Internet protocol security (IPSec). According to an embodiment, a first communication device determines, for an IPSec packet to be sent to a second communication device, whether the IPSec packet needs layer 4 (L4) encapsulation. When determining that the IPSec packet needs L4 encapsulation, the first communication device determines whether a first condition that a maximum transmission unit (MTU) of the encapsulated IPSec packet after the L4 encapsulation exceeds a target MTU negotiated between the first and second communication devices is satisfied. When determining that the first condition is satisfied, the first communication device fragments the IPSec packet into fragments so that the MTU of each encapsulated fragment after the L4 encapsulation does not exceed the negotiated target MTU.

### TECHNICAL FIELD

Embodiments of the disclosure generally relate to communication, and, more particularly, to a method and a communication device for communication using Internet protocol security (IPSec).

### BACKGROUND

This section introduces aspects that may facilitate better understanding of the present disclosure. Accordingly, the statements of this section are to be read in this light and are not to be understood as admissions about what is in the prior art or what is not in the prior art.

Internet protocol (IP) security (IPSec) provides confidentiality, data integrity, access control, and data source authentication to IP datagrams. These services are provided by maintaining shared state between the source and the sink of an IP datagram. This state defines, among other things, the specific services provided to the datagram, which cryptographic algorithms will be used to provide the services, and the keys used as input to the cryptographic algorithms.

Internet key exchange (IKE) performs mutual authentication between two parties and establishes an IKE security association (SA). The IKE SA includes shared secret information that can be used to efficiently establish SAs for encapsulating security payload (ESP) or authentication header (AH), and a set of cryptographic algorithms to be used by the SAs to protect the traffic that they carry.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for communication using IPSec. In particular, one of the problems to be solved by the disclosure is that the existing solution may result in packet loss in IPSec over layer 4 (L4) encapsulation scenarios.

According to a first aspect of the disclosure, there is provided a method performed by a first communication device. The method may comprise determining, for an IPSec packet to be sent to a second communication device, whether the IPSec packet needs L4 encapsulation. The method may further comprise, when determining that the IPSec packet needs L4 encapsulation, determining whether a first condition that a maximum transmission unit (MTU) of the encapsulated IPSec packet after the L4 encapsulation exceeds a target MTU negotiated between the first and second communication devices is satisfied. The method may further comprise, when determining that the first condition is satisfied, fragmenting the IPSec packet into fragments so that the MTU of each encapsulated fragment after the L4 encapsulation does not exceed the negotiated target MTU.

In this way, it is possible to avoid packet loss in IPSec over L4 encapsulation scenarios.

In an embodiment of the disclosure, the method may further comprise negotiating the target MTU with the second communication device.

In an embodiment of the disclosure, negotiating the target MTU with the second communication device may comprise sending, to the second communication device, a first message for authentication of the first communication device. The first message may comprise a first MTU allowed for a first forwarding path from the second communication device to the first communication device. Negotiating the target MTU with the second communication device may further comprise receiving, from the second communication device, a second message in response to the first message. The second message may comprise a second MTU allowed for a second forwarding path from the first communication device to the second communication device. The negotiated target MTU may be the second MTU.

In an embodiment of the disclosure, the first message and the second message may be messages used in Internet key exchange (IKE) protocol. A field “Notify Message Type” in “Notify Payload” used in IKE protocol may be extended to indicate a new notification type, and a filed “Notification Data” corresponding to the new notification type may carry a value of the first MTU or the second MTU.

In an embodiment of the disclosure, the IPSec packet may be determined to need the L4 encapsulation, in response to one or more of following events: the IPSec packet is over network address translation (NAT); the L4 encapsulation is helpful for load balancing; and the L4 encapsulation is helpful for avoiding IPSec traffic from being blocked.

In an embodiment of the disclosure, the method may further comprise determining whether a second condition that a target MTU has been successfully negotiated between the first and second communication devices is satisfied. Whether the first condition is satisfied may be determined when determining that the second condition is satisfied.

In an embodiment of the disclosure, the first communication device may be one of: a security gateway; a firewall; a router; a server; and a user equipment.

According to a second aspect of the disclosure, there is provided a first communication device. The first communication device may comprise at least one processor and at least one memory. The at least one memory may contain instructions executable by the at least one processor, whereby the first communication device may be operative to determine, for an IPSec packet to be sent to a second communication device, whether the IPSec packet needs L4 encapsulation. The first communication device may be further operative to, when determining that the IPSec packet needs L4 encapsulation, determine whether a first condition that an MTU of the encapsulated IPSec packet after the L4 encapsulation exceeds a target MTU negotiated between the first and second communication devices is satisfied. The first communication device may be further operative to, when determining that the first condition is satisfied, fragment the IPSec packet into fragments so that the MTU of each encapsulated fragment after the L4 encapsulation does not exceed the negotiated target MTU.

In this way, it is possible to avoid packet loss in IPSec over L4 encapsulation scenarios.

In an embodiment of the disclosure, the first communication device may be further operative to negotiate the target MTU with the second communication device.

In an embodiment of the disclosure, the first communication device may be operative to negotiate the target MTU with the second communication device by sending, to the second communication device, a first message for authentication of the first communication device. The first message may comprise a first MTU allowed for a first forwarding path from the second communication device to the first communication device. The first communication device may be operative to negotiate the target MTU with the second communication device by receiving, from the second communication device, a second message in response to the first message. The second message may comprise a second MTU allowed for a second forwarding path from the first communication device to the second communication device. The negotiated target MTU may be the second MTU.

In an embodiment of the disclosure, the first message and the second message may be messages used in IKE protocol. A field “Notify Message Type” in “Notify Payload” used in IKE protocol may be extended to indicate a new notification type, and a filed “Notification Data” corresponding to the new notification type may carry a value of the first MTU or the second MTU.

In an embodiment of the disclosure, the first communication device may be operative to determine that the IPSec packet needs the L4 encapsulation, in response to one or more of following events: the IPSec packet is over NAT; the L4 encapsulation is helpful for load balancing; and the L4 encapsulation is helpful for avoiding IPSec traffic from being blocked.

In an embodiment of the disclosure, the first communication device may be further operative to determine whether a second condition that a target MTU has been successfully negotiated between the first and second communication devices is satisfied. The first communication device may be operative to determine whether the first condition is satisfied when determining that the second condition is satisfied.

In an embodiment of the disclosure, the first communication device may be one of: a security gateway; a firewall; a router; a server; and a user equipment.

According to a third aspect of the disclosure, there is provided a computer program product. The computer program product may contain instructions which when executed by at least one processor, cause the at least one processor to perform the method according to the above first aspect.

According to a fourth aspect of the disclosure, there is provided a computer readable storage medium. The computer readable storage medium may store thereon instructions which when executed by at least one processor, cause the at least one processor to perform the method according to the above first aspect.

According to a fifth aspect of the disclosure, there is provided a first communication device. The first communication device may comprise a first determination module for determining, for an IPSec packet to be sent to a second communication device, whether the IPSec packet needs L4 encapsulation. The first communication device may further comprise a second determination module for, when determining that the IPSec packet needs L4 encapsulation, determining whether a first condition that an MTU of the encapsulated IPSec packet after the L4 encapsulation exceeds a target MTU negotiated between the first and second communication devices is satisfied. The first communication device may further comprise a fragmentation module for, when determining that the first condition is satisfied, fragmenting the IPSec packet into fragments so that the MTU of each encapsulated fragment after the L4 encapsulation does not exceed the negotiated target MTU.

In an embodiment of the disclosure, the first communication device may further comprise a negotiating module for negotiating the target MTU with the second communication device.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an exemplary scenario in which the problem in the existing solution may happen;

FIGS. 2A-2B are diagrams illustrating the structures of IPSec packet and UDP-encapsulated IPSec packet respectively;

FIGS. 3A-3B are diagrams illustrating fragmentation of UDP-encapsulated IPSec packet;

FIG. 4 is a flowchart illustrating a method performed by a first communication device according to an embodiment of the disclosure;

FIG. 5 is a flowchart illustrating a method performed by a first communication device according to an embodiment of the disclosure;

FIG. 6 is a flowchart for explaining the method of FIG. 5;

FIG. 7 is a flowchart illustrating the existing process of IKE session establishment;

FIGS. 8A-8B are diagrams illustrating the formats of Notify Payload;

FIG. 9 is a flowchart illustrating an exemplary process of IKE session establishment according to an embodiment of the disclosure;

FIG. 10 is a flowchart illustrating a method performed by a first communication device according to an embodiment of the disclosure;

FIG. 11 is a block diagram showing an apparatus suitable for use in practicing some embodiments of the disclosure;

FIG. 12 is a block diagram showing a first communication device according to an embodiment of the disclosure;

FIG. 13 is a flowchart illustrating an exemplary process according to an embodiment of the disclosure; and

FIG. 14 is a diagram illustrating an exemplary process performed by a second communication device.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Internet key exchange (IKE) protocol could be encapsulated and decapsulated inside user datagram protocol (UDP) packets for traversing network address translators (NATs), which is a very familiar scenario. After the IKE negotiation over NAT is done following request for comments 3948 (RFC 3948), the data plane traffic is encrypted with the key generated by IKE protocol, and uses UDP encapsulation with destination port 4500.

Fragmentation of an Internet datagram is necessary when it originates in a local net that allows a large packet size and must traverse a local net that limits packets to a smaller size to reach its destination. The Internet fragmentation and reassembly procedure needs to be able to break a datagram into an almost arbitrary number of pieces that can be later reassembled.

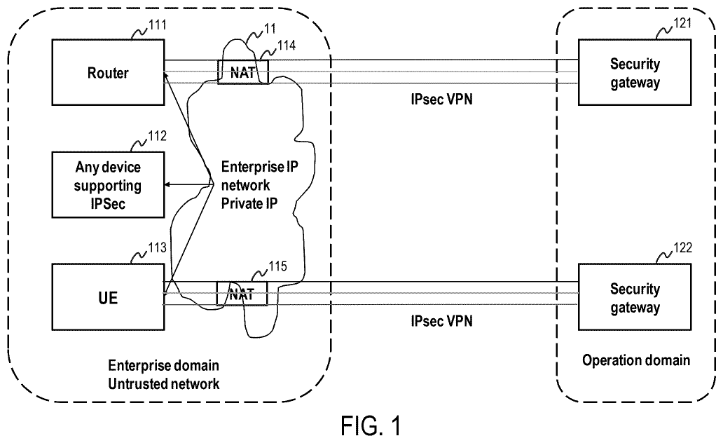

FIG. 1 is a diagram illustrating an exemplary scenario in which the problem in the existing solution may happen. As shown, a router 111, or a user equipment (UE) 113, or any other device 112 supporting IPSec is in an enterprise IP network 11. An IPSec virtual private network (VPN) connection is established between the router 111 and a security gateway 121 in an operation domain via a network address translator (NAT) 114. Another IPSec VPN connection is established between the UE 113 and a security gateway 122 in the operation domain via an NAT 115. It is a common situation that the enterprise IP network 11 is an untrusted IP network which cannot be controlled by customer. So IPSec is needed to protect the transmission security on this network segment. In this IP network, the maximum transmission unit (MTU) of each router is unknown meanwhile the MTU of each router cannot be modified.

From the application view, it is impossible to change the maximum size of sent packet because it is unknown how many applications need to be changed, and it is also unknown what size is suitable to change to. So the IPSec encapsulating security payload (ESP) packets may be fragmented when crossing the public network.

Besides the above topology shown in FIG. 1, some other scenarios could also lead to the same result (i.e. IPSec data plane has layer 4 (L4) encapsulation but may be fragmented). As an example, as described in Internet engineering task force (IETF) draft draft-xu-ipsecme-esp-in-udp-lb-09, sometimes the IPSec packets need to be encapsulated into UDP actively because of the load balancing reason. As another example, as described in RFC 8229, in some use case the IPSec packets may be encapsulated into transmission control protocol (TCP). For instance, many network middle-boxes that filter traffic on public hotspots block all UDP traffic, including IKE and IPSec, but allow TCP connections through because they appear to be web traffic. Devices on these networks that need to use IPSec (to access private enterprise networks, to route voice over IP (VOIP) calls to carrier networks, or because of security policies) are unable to establish IPSec SAs. So IPSec over TCP is needed in such use case.

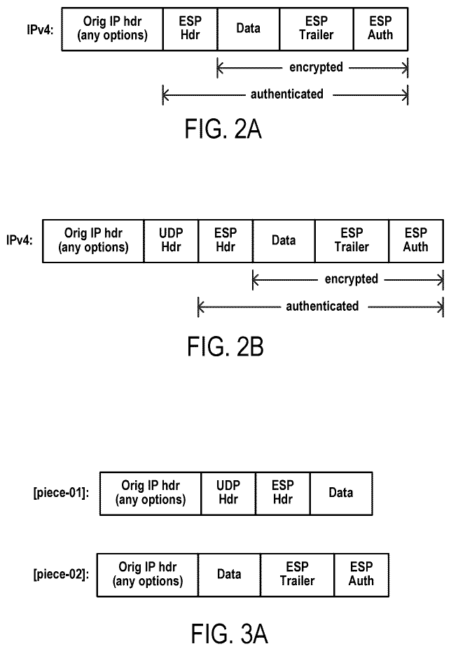

FIG. 2A illustrates the format of an IPSec packet with typical ESP encapsulation. Note that IP version 4 (IPv4) is merely taken as an example for illustration purpose. The term “Orig” refers to originator, the term “hdr” refers to header, and the term “Auth” refers to authentication. FIG. 2B illustrate the format of a UDP-encapsulated IPSec packet. As shown, the UDP header is inserted between the originator IP header and the ESP header.

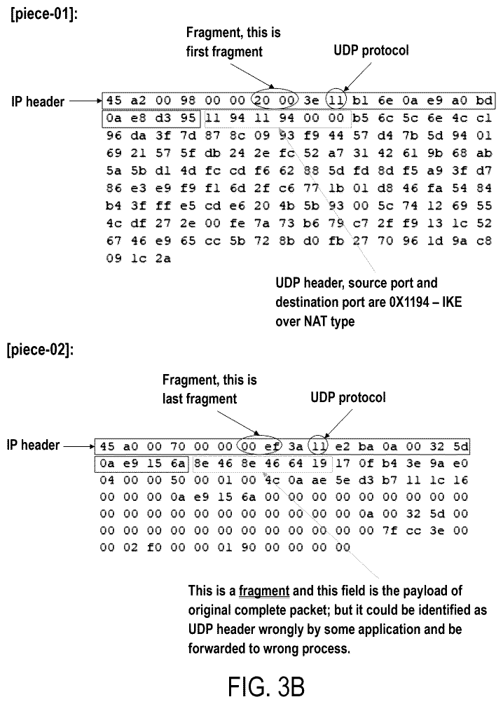

FIG. 3A illustrates the format of fragmented UDP-encapsulated ESP packet. As shown, in this example, the UDP-encapsulated ESP packet is fragmented into two pieces of fragments. Only the initial fragment “piece-01” carries the UDP header and the non-initial fragment “piece-02” carries the IP payload after the IP header. FIG. 3B illustrates the two pieces of fragments in more details. As shown in FIG. 3B, the fragment “piece-01” carries the UDP header in which the source port and destination port are 0X1194 indicating IKE over NAT type. Since the fragment “piece-02” has no UDP header, the content at the corresponding position in the fragment “piece-02” belongs to the payload of the original complete packet. Thus, it could be identified as UDP header wrongly by some application and be forwarded to wrong process.

Therefore, in the IKE over NAT scenario of FIG. 1, or some other scenarios described in RFC 8229 and draft-xu-ipsecme-esp-in-udp-lb-09 in which IPSec packets also have L4 encapsulation, the protocol ID in the IP header after fragmentation is UDP (17) due to the use of UDP encapsulation, or the protocol ID is 6 due to the use of TCP encapsulation. Note that since TCP encapsulation has the same problem with UDP encapsulation, so only UDP is used here to describe the problem as an example. Because only the initial fragment carries the correct UDP header and non-initial fragments carry the IP payload after the IP header, the non-initial fragment may be incorrectly identified as other protocol packets and be incorrectly processed by the router on the transmission path causing traffic to be broken.

Currently, for the above problem, there is no suitable solution for IKE version 2 (IKEv2) and IPSec in the industry. Therefore, it would be desirable to provide a feasible solution to let IPSec over NAT case (or other case which needs to add L4 encapsulation for IPSec) work perfectly.

The present disclosure proposes an improved solution for communication using IPSec. The basic idea of the present disclosure is to pre-fragment IPSec data plane packets to resolve the fragmentation problem of IPSec over L4 encapsulation. As an exemplary example, IPSec Notify Type may be extended to negotiate whether IPSec over L4 encapsulation can be pre-fragmented in the session. Scenarios of IPSec packets over L4 encapsulation may be identified. For the IPSec packets over L4 encapsulation that may be fragmented on the forwarding path (because the packet length is long), pre-fragmentation may be performed. This can protect services from packet loss caused by failure to identify non-initial fragments of IPSec packets over L4 encapsulation.

The solution of the present disclosure can be applicable to any communication device that uses or supports IPSec, including terminal device (or UE) or any other suitable intelligent device, since it is common for a terminal device to connect with a server through virtual private network (VPN) which is usually based on IPSec, and terminal devices usually need to be over NAT to use IPSec.

Within the context of this disclosure, the term terminal device may also be referred to as, for example, UE, access terminal, device, mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

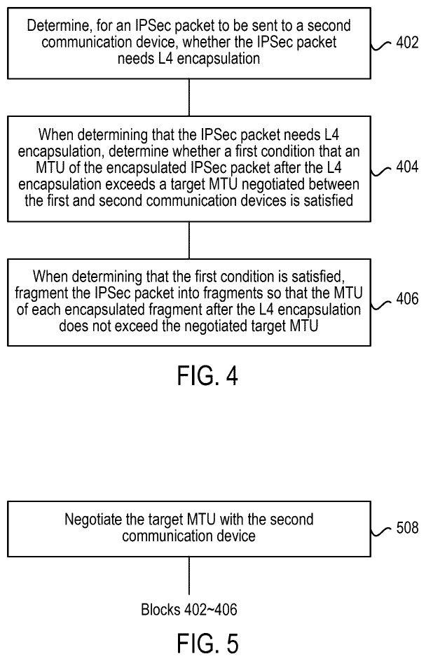

Hereinafter, the solution will be described in detail with reference to FIGS. 4-14. FIG. 4 is a flowchart illustrating a method performed by a first communication device according to an embodiment of the disclosure. The first communication device may be any communication device capable of supporting IPSec. Examples of the first communication device may include, but not limited to, a security gateway, a firewall, a router, a server, a UE (or a terminal device), etc. The method of FIG. 4 may be performed by a data plane of the first communication device. At block 402, the first communication device determines, for an IPSec packet to be sent to a second communication device, whether the IPSec packet needs layer 4 (L4) encapsulation. The first communication device may be one endpoint of an IPSec session and the second communication device may be the other endpoint of the IPSec session. The layer 4 may refer to the fourth layer (transport layer) of the seven layers defined in open system interconnection (OSI) architecture. The L4 encapsulation may be e.g. UDP encapsulation or TCP encapsulation. As an example, the IPSec packet may be determined to need the L4 encapsulation, in response to an event that the IPSec packet is over (or is to pass through) network address translation (NAT). As another example, the IPSec packet may be determined to need the L4 encapsulation, in response to an event that the L4 encapsulation (e.g. UDP encapsulation) is helpful for load balancing (e.g. as mentioned in IETF draft draft-xu-ipsecme-esp-in-udp-lb-09). As yet another example, the IPSec packet may be determined to need the L4 encapsulation, in response to an event that the L4 encapsulation (e.g. TCP encapsulation) is helpful for avoiding IPSec traffic from being blocked (e.g. as mentioned in RFC 8229).

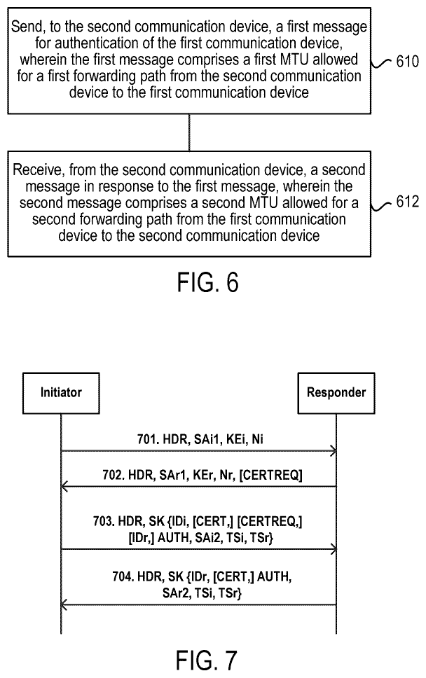

When determining that the IPSec packet needs L4 encapsulation, the first communication device determines, at block 404, whether a first condition that an MTU of the encapsulated IPSec packet after the L4 encapsulation exceeds a target MTU negotiated between the first and second communication devices is satisfied. The MTU can define the largest size of a packet that can be transmitted as a single entity in a network connection. When a packet is generated, the MTU of the packet can be determined. For an IP packet, the relation between the size of the packet and the MTU of the packet can be expressed as: the MTU is the part outside the Ethernet header and CRC bytes. The negotiation of the target MTU may be performed by a control plane of the first communication device and will be described later with reference to FIG. 6.

When determining that the first condition is satisfied, the first communication device fragments the IPSec packet into fragments so that the MTU of each encapsulated fragment after the L4 encapsulation does not exceed the negotiated target MTU, at block 406. Because of the fragmentation, each encapsulated fragment after the L4 encapsulation can be forwarded to the second communication device without any further fragmentation in the forwarding path, thereby avoiding packet loss in IPSec over L4 encapsulation scenarios.

FIG. 5 is a flowchart illustrating a method performed by a first communication device according to an embodiment of the disclosure. The method may be performed by a control plane of the first communication device. As shown, the method comprises block 508, and blocks 402-406 as described above. At block 508, the first communication device negotiates the target MTU with a second communication device. The target MTU and the second communication device have been described above with reference to blocks 402-406. Block 508 may be implemented as blocks 610-612 of FIG. 6. At block 610, the first communication device sends, to the second communication device, a first message for authentication of the first communication device. The first message may comprise a first MTU allowed for a first forwarding path from the second communication device to the first communication device. The first MTU can be obtained by various ways, such as deployment based on the customer's knowledge of the entire network, or using Traceroute tool, or any other suitable techniques. Besides the first MTU, other content contained in the first message may be similar to that contained in the corresponding message for the authentication stage of IKE protocol. At block 612, the first communication device receives, from the second communication device, a second message in response to the first message. The second message comprises a second MTU allowed for a second forwarding path from the first communication device to the second communication device. The second MTU may be used as the negotiated target MTU. Similarly, the second MTU can be obtained by various ways, such as deployment based on the customer's knowledge of the entire network, or using Traceroute tool, or any other suitable techniques. Besides the second MTU, other content contained in the second message may be similar to that contained in the corresponding message for the authentication stage of IKE protocol.

As an exemplary example, the first message and the second message may be messages used in IKE protocol. A field “Notify Message Type” in “Notify Payload” used in IKE protocol may be extended to indicate a new notification type. A filed “Notification Data” corresponding to the new notification type may carry the value of the first/second MTU contained in the first/second message.

For ease of understanding, FIG. 7 illustrates the existing process of IKE session establishment. Firstly, in the IKE_SA_INIT stage, steps 701 and 702 are performed. At step 701, the initiator sends, to the responder, a message containing HDR, SAi1, KEi, and Ni. HDR contains the security parameter indexes (SPIs), version numbers, and flags of various sorts. The SAi1 payload states the cryptographic algorithms the initiator supports for the IKE SA. The KE payload sends the initiator's Diffie-Hellman value. The Ni is the initiator's nonce. At step 702, the responder replies, to the initiator, a response message containing HDR, SAr1, KEr, Nr, and optionally CERTREQ. Specifically, the responder chooses a cryptographic suite from the initiator's offered choices and expresses that choice in the SAr1 payload, completes the Diffie-Hellman exchange with the KEr payload, and sends its nonce in the Nr payload. The CERTREQ may be used for requesting the certificate of the initiator.

Secondly, in the IKE_AUTH stage, steps 703 and 704 are performed. At step 703, the initiator sends, to the responder, a message containing HDR, SK {IDi, [CERT,] [CERTREQ,] [IDr,] AUTH, SAi2, TSi, TSr}. The “SK { }” means the part contained in SK { } is encrypted, and “[ ]” refers to optional parameter. Specifically, the initiator asserts its identity with the IDi payload, proves knowledge of the secret corresponding to IDi and integrity protects the contents of this message using the AUTH payload. The initiator might also send its certificate(s) in CERT payload(s) and a list of its trust anchors in CERTREQ payload(s). The initiator begins negotiation of a Child SA using the SAi2 Payload. The Traffic Selectors (TSi and TSr) are used to create child SAs. At step 704, the responder replies, to the initiator, a response message containing HDR, SK {IDr, [CERT,] AUTH, SAr2, TSi, TSr}. Specifically, the responder asserts its identity with the IDr payload, optionally sends one or more certificates (again with the certificate containing the public key used to verify AUTH listed first), authenticates its identity and protects the integrity of the second message with the AUTH payload, and completes negotiation of a Child SA with the additional fields in the CREATE_CHILD_SA exchange. More details of the above process can be obtained from the RFC 7296.

In the above exemplary example, the first message sent from the first communication device to the second communication device may be implemented by using the message sent at step 703. The second message received from the second communication device by the first communication device may be implemented by using the message sent at step 704. The extended filed “Notify Message Type” is shown in Table 1 below, where the extended content is highlighted with underlines and the “TBD” means “to be defined”.

TABLE 1
Extended filed “Notify Message Type”

| Value | Notify Message Type |
|---|---|
| 16434 | PUZZLE |
| 16435 | USE_PPK |
| 16436 | PPK_IDENTITY |
| 16437 | NO_PPK_AUTH |
| 16438 | INTERMEDIATE_EXCHANGE_SUPPORTED |
| 16439 | IP4_ALLOWED |
| 16440 | IP6_ALLOWED |
| TBD | L4_ENCAP_FRAG |

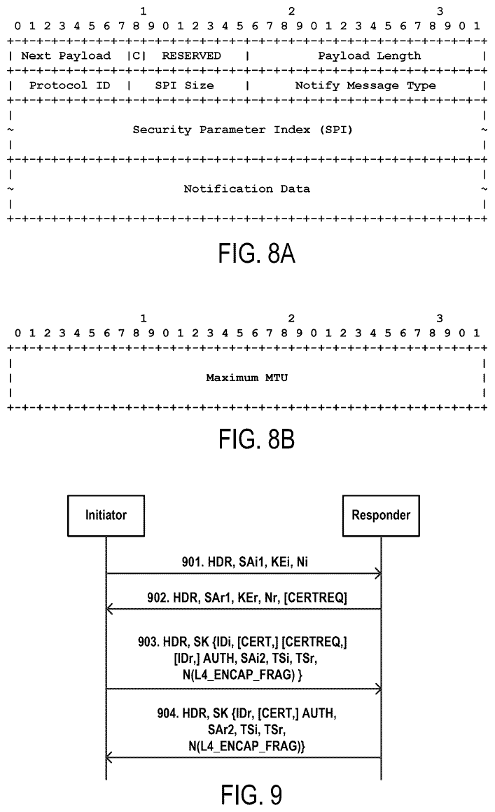

FIG. 8A illustrates the format of Notify Payload. The “Next Payload” having the value of 41 indicates this is Notify payload. The “C” can take the value of 0 to tell the recipient to skip this payload if it does not understand the payload type code. The “Protocol ID” can take the value of 0 to indicate this payload is not concerning the SPI. The “SPI Size” can take the value of 0 to indicate this payload is not concerning the SPI.

For indicating the first/second MTU contained in the first/second message in the above exemplary example, the filed “Notify Message Type” in the format of FIG. 8A may indicate the extended type “L4_ENCAP_FRAG” and take the new extended value which is different from those having been defined for this field (in Table 1, the extended value is marked as “TBD” which depends on implementation). Correspondingly, the field “Notification Data” in the format of FIG. 8A may carry the value of the first/second MTU, as shown in FIG. 8B. The notification data for the new proposed “Notify Message Type” can be 4 octets, indicating the MTU allowed for this session in the IPSec over L4 encapsulation scenario. If the MTU exceeds this value after encryption and L4 encapsulation, pre-fragmentation is required. This value can be configured by user, and the default value in non-configured case is suggested to 1500 by following industry standard.

FIG. 9 illustrates an exemplary process of IKE session establishment in the above exemplary example. It involves an IKEv2 negotiation (or exchange) session using notify type “L4_ENCAP_FRAG”, which can resolve the issue that non-initial fragments in IPSec over L4 encapsulation case cannot be handled. The IKE_SA_INIT stage is the same as that shown in FIG. 7 and its details are omitted here. In the IKE_AUTH stage, at step 903, the initiator sends, to the responder, a message containing HDR, SK {IDi, [CERT,] [CERTREQ,] IDr,] AUTH, SAi2, TSi, TSr, N(L4 ENCAP FRAG)}. The underlined part is newly added payload in IKE_AUTH initiation message. The N(L4_ENCAP_FRAG) means “MTU allowed in IPSec over L4 encapsulation case” from initiator side, and the content can be the MTU configured on the initiator. At step 904, the responder replies, to the initiator, a response message containing HDR, SK {IDr, [CERT,] AUTH, SAr2, TSi, TSr, N(L4 ENCAP FRAG)}. The underlined part is newly added payload in IKE_AUTH responding message. N(L4_ENCAP_FRAG) means “MTU allowed in IPSec over L4 encapsulation case” from the responder side, and the content can be the MTU configured on the responder. After the IKEv2 session negotiation, the IPSec data plane can know whether it is in the IPSec over L4 encapsulation scenario.

Referring back to FIG. 5, at block 402, the first communication device determines, for an IPSec packet to be sent to the second communication device, whether the IPSec packet needs L4 encapsulation. At block 404, when determining that the IPSec packet needs L4 encapsulation, the first communication device determines whether a first condition that an MTU of the encapsulated IPSec packet after the L4 encapsulation exceeds the target MTU negotiated between the first and second communication devices is satisfied. At block 406, when determining that the first condition is satisfied, the first communication device fragments the IPSec packet into fragments so that the MTU of each encapsulated fragment after the L4 encapsulation does not exceed the negotiated target MTU. With the method of FIG. 5, it is possible to avoid packet loss in IPSec over L4 encapsulation scenarios. Note that two blocks shown in succession in the figures of the present document may, in fact, be executed substantially concurrently, or the blocks may sometimes be executed in the reverse order, depending upon the functionality involved.

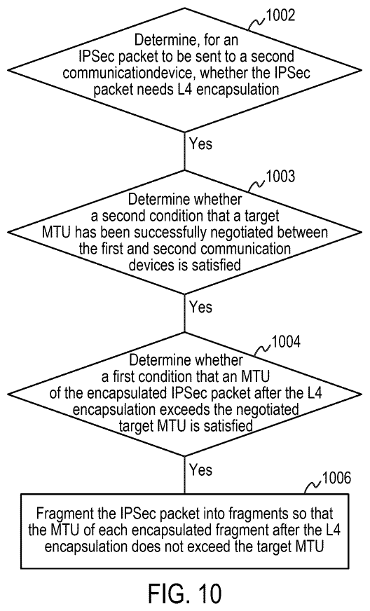

FIG. 10 is a flowchart illustrating a method performed by a first communication device according to an embodiment of the disclosure. The method may be performed by a data plane of the first communication device. At block 1002, the first communication device determines, for an IPSec packet to be sent to the second communication device, whether the IPSec packet needs L4 encapsulation. When the determination result at block 1002 is positive, at block 1003, the first communication device determines whether a second condition that a target MTU has been successfully negotiated between the first and second communication devices is satisfied. When the determination result at block 1003 is positive, at block 1004, the first communication device determines whether a first condition that an MTU of the encapsulated IPSec packet after the L4 encapsulation exceeds the target MTU negotiated between the first and second communication devices is satisfied. When the determination result at block 1004 is positive, at block 1006, the first communication device fragments the IPSec packet into fragments so that the MTU of each encapsulated fragment after the L4 encapsulation does not exceed the negotiated target MTU. With the method of FIG. 10, it is possible to avoid packet loss in IPSec over L4 encapsulation scenarios.

Based on the above description, at least one aspect of the present disclosure provides a method performed by a first communication device. The method comprises sending, to a second communication device, a first message for authentication of the first communication device. The first message comprises a first MTU allowed for a first forwarding path from the second communication device to the first communication device. The method further comprises receiving, from the second communication device, a second message in response to the first message. The second message comprises a second MTU allowed for a second forwarding path from the first communication device to the second communication device.

Correspondingly, at least one aspect of the present disclosure provides a method performed by a second communication device. The method comprises receiving, from a first communication device, a first message for authentication of the first communication device. The first message comprises a first MTU allowed for a first forwarding path from the second communication device to the first communication device. The method further comprises sending, to the first communication device, a second message in response to the first message. The second message comprises a second MTU allowed for a second forwarding path from the first communication device to the second communication device.

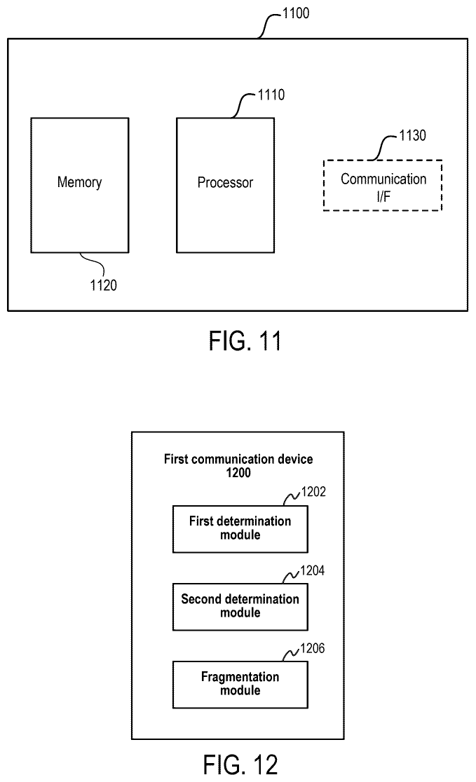

FIG. 11 is a block diagram showing an apparatus suitable for use in practicing some embodiments of the disclosure. For example, the first communication device and the second communication device described above may be implemented through the apparatus 1100. As shown, the apparatus 1100 may include a processor 1110, a memory 1120 that stores a program, and optionally a communication interface 1130 for communicating data with other external devices through wired and/or wireless communication.

The program includes program instructions that, when executed by the processor 1110, enable the apparatus 1100 to operate in accordance with the embodiments of the present disclosure, as discussed above. That is, the embodiments of the present disclosure may be implemented at least in part by computer software executable by the processor 1110, or by hardware, or by a combination of software and hardware.

The memory 1120 may be of any type suitable to the local technical environment and may be implemented using any suitable data storage technology, such as semiconductor based memory devices, flash memories, magnetic memory devices and systems, optical memory devices and systems, fixed memories and removable memories. The processor 1110 may be of any type suitable to the local technical environment, and may include one or more of general purpose computers, special purpose computers, microprocessors, digital signal processors (DSPs) and processors based on multi-core processor architectures, as non-limiting examples.

FIG. 12 is a block diagram showing a first communication device according to an embodiment of the disclosure. As shown, the first communication device 1200 comprises a first determination module 1202, a second determination module 1204 and a fragmentation module 1206. The first determination module 1202 may be configured to determine, for an IPSec packet to be sent to a second communication device, whether the IPSec packet needs L4 encapsulation, as described above with respect to block 402. The second determination module 1204 may be configured to, when determining that the IPSec packet needs L4 encapsulation, determine whether a first condition that an MTU of the encapsulated IPSec packet after the L4 encapsulation exceeds a target MTU negotiated between the first and second communication devices is satisfied, as described above with respect to block 404. The fragmentation module 1206 may be configured to, when determining that the first condition is satisfied, fragment the IPSec packet into fragments so that the MTU of each encapsulated fragment after the L4 encapsulation does not exceed the negotiated target MTU, as described above with respect to block 406. Optionally, the first communication device may further comprise a negotiating module for negotiating the target MTU with the second communication device. The modules described above may be implemented by hardware, or software, or a combination of both.

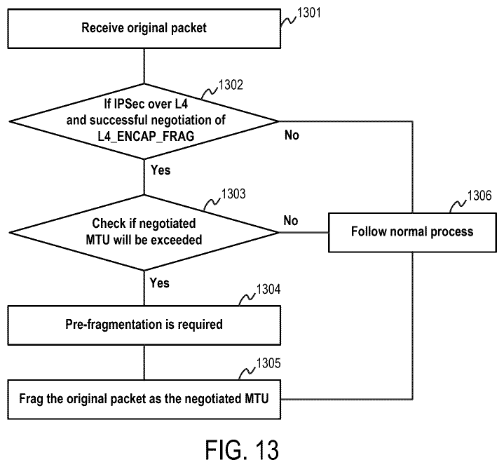

FIG. 13 is a flowchart illustrating an exemplary process according to an embodiment of the disclosure. The process may be performed by a data plane of a first communication device (or an IPSec packet sender). At block 1301, the first communication device receives an original packet. Note that the original packet may also be generated by the first communication device (e.g. in the scenario where the first communication device is a UE). At block 1302, the first communication device determines whether 1) IPSec over L4 encapsulation is required and 2) successful negotiation of L4_ENCAP_FRAG has been performed. If the determination results for both 1) and 2) are positive, the process proceeds to block 1303. On the other hand, if the determination result for either one of 1) and 2) is negative, the process proceeds to block 1306 where the normal process is performed.

At block 1303, the first communication device checks whether the negotiated MTU will be exceeded by the encapsulated packet after the L4 encapsulation. If the determination result at block 1303 is positive, the process proceeds to block 1304 where it is determined that pre-fragmentation is required. At block 1305, the first communication device fragments the original packet as the negotiated MTU. On the other hand, if the determination result at block 1303 is negative, the process proceeds to block 1306 where the normal process is performed.

In the above process, in the case of IPSec over L4 encapsulation and successful negotiation of L4_ENCAP_FRAG, the IPSec data plane calculates the MTU of each packet after encapsulation and encryption, and checks whether the MTU after encryption and encapsulation exceeds the MTU negotiated by L4_ENCAP_FRAG. If the MTU exceeds the MTU negotiated by L4_ENCAP_FRAG, the IPSec data plane fragments the original packets according to the MTU negotiated. Then each fragment is individually encrypted and encapsulated by IPSec, and finally be forwarded.

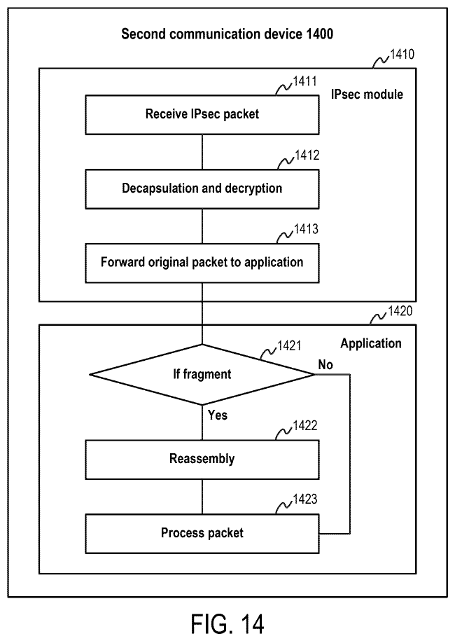

FIG. 14 is a diagram illustrating an exemplary process performed by a second communication device (or an IPSec packet receiver). As shown, the second communication device 1400 may comprise an IPSec module 1410 and an application 1420. Blocks 1411-1413 may be performed by the IPSec module 1410 and blocks 1421-1423 may be performed by the application 1420. At block 1411, the IPSec module receives an IPSec packet. At block 1412, decapsulation and decryption is performed. At block 1413, the original packet is forwarded to the application. At block 1421, the application determines whether the packet is a fragment. If the packet is a fragment, the reassembly operation is performed at block 1422 and the reassembled packet is processed at block 1423. On the other hand, if the packet is not a fragment, the packet is processed at block 1423.

It can be seen that because pre-fragmentation is performed at the IPSec packet sender so that each encapsulated fragment after the L4 encapsulation can be forwarded to the IPSec packet receiver without any further fragmentation in the forwarding path, on the receiving end of IPSec packets, the receiver does not need to perform any special operations, but decrypt and forward IPSec packets according to the normal process. The applications that need to receive the original packets (or messages) can naturally complete message reassembly. In this way, the service loss caused by failure to identify non-initial fragments in IPSec over L4 encapsulation can be avoided. Note that the packet finally processed by the application may be used by the IPSec packet receiver itself, or may be used by another communication device.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a first communication device, comprising:
determining, for an Internet protocol security, IPSec, packet to be sent to a second communication device, whether the IPSec packet needs layer 4, L4, encapsulation;
when determining that the IPSec packet needs L4 encapsulation, determining whether a first condition that a maximum transmission unit, MTU, of the encapsulated IPSec packet after the L4 encapsulation exceeds a target MTU negotiated between the first and second communication devices is satisfied; and
when determining that the first condition is satisfied, fragmenting the IPSec packet into fragments so that the MTU of each encapsulated fragment after the L4 encapsulation does not exceed the negotiated target MTU.

2. The method according to claim 1, further comprising:
negotiating the target MTU with the second communication device.

3. The method according to claim 2, wherein negotiating the target MTU with the second communication device comprises:
sending, to the second communication device, a first message for authentication of the first communication device, wherein the first message comprises a first MTU allowed for a first forwarding path from the second communication device to the first communication device; and
receiving, from the second communication device, a second message in response to the first message, wherein the second message comprises a second MTU allowed for a second forwarding path from the first communication device to the second communication device; and
wherein the negotiated target MTU is the second MTU.

4. The method according to claim 3, wherein the first message and the second message are messages used in Internet key exchange, IKE, protocol; and
wherein a field “Notify Message Type” in “Notify Payload” used in IKE protocol is extended to indicate a new notification type, and a filed “Notification Data” corresponding to the new notification type carries a value of the first MTU or the second MTU.

5. The method according to claim 1, wherein the IPSec packet is determined to need the L4 encapsulation, in response to one or more of following events:
the IPSec packet is over network address translation, NAT;
the L4 encapsulation is helpful for load balancing; and
the L4 encapsulation is helpful for avoiding IPSec traffic from being blocked.

6. The method according to claim 1, further comprising: determining whether a second condition that a target MTU has been successfully negotiated between the first and second communication devices is satisfied; and
wherein whether the first condition is satisfied is determined when determining that the second condition is satisfied.

7. The method according to claim 1, wherein the first communication device is one of:
a security gateway;
a firewall;
a router;
a server; and
a user equipment.

8. A first communication device comprising:
at least one processor; and
at least one memory, the at least one memory containing instructions executable by the at least one processor, whereby the first communication device is operative to:
determine, for an Internet protocol security, IPSec, packet to be sent to a second communication device, whether the IPSec packet needs layer 4, L4, encapsulation;
when determining that the IPSec packet needs L4 encapsulation, determine whether a first condition that a maximum transmission unit, MTU, of the encapsulated IPSec packet after the L4 encapsulation exceeds a target MTU negotiated between the first and second communication devices is satisfied; and
when determining that the first condition is satisfied, fragment the IPSec packet into fragments so that the MTU of each encapsulated fragment after the L4 encapsulation does not exceed the negotiated target MTU.

9. The first communication device according to claim 8, wherein the first communication device is further operative to:
negotiate the target MTU with the second communication device.

10. The first communication device according to claim 9, wherein the first communication device is operative to negotiate the target MTU with the second communication device by:
sending, to the second communication device, a first message for authentication of the first communication device, wherein the first message comprises a first MTU allowed for a first forwarding path from the second communication device to the first communication device; and
receiving, from the second communication device, a second message in response to the first message, wherein the second message comprises a second MTU allowed for a second forwarding path from the first communication device to the second communication device; and
wherein the negotiated target MTU is the second MTU.

11. The first communication device according to claim 10, wherein the first message and the second message are messages used in Internet key exchange, IKE, protocol; and
wherein a field “Notify Message Type” in “Notify Payload” used in IKE protocol is extended to indicate a new notification type, and a filed “Notification Data” corresponding to the new notification type carries a value of the first MTU or the second MTU.

12. The first communication device according to claim 8, wherein the first communication device is operative to determine that the IPSec packet needs the L4 encapsulation, in response to one or more of following events:
the IPSec packet is over network address translation, NAT;
the L4 encapsulation is helpful for load balancing; and
the L4 encapsulation is helpful for avoiding IPSec traffic from being blocked.

13. The first communication device according to claim 8, wherein the first communication device is further operative to: determine whether a second condition that a target MTU has been successfully negotiated between the first and second communication devices is satisfied; and
wherein the first communication device is operative to determine whether the first condition is satisfied when determining that the second condition is satisfied.

14. The first communication device according to claim 8, wherein the first communication device is one of:
a security gateway;
a firewall;
a router;
a server; and
a user equipment.

15. A computer readable storage medium storing thereon instructions which when executed by at least one processor, cause the at least one processor to perform the method according to claim 1.
